(19) United States
(12) Patent Application Publication
(10) Pub. No.: US 2026/0207419 A1
(43) Pub. Date: Jul. 23, 2026

(54) SEXUAL STIMULATION DEVICE AND SEXUAL TOY

(71) Applicant: Dongguan love angel electronic technology Co., Ltd., Dongguan. (CN)

(72) Inventors: Yanna Chen, Dongguan (CN); Hao Chen, Dongguan (CN)

(21) Appl. No.: 19/457,516

(22) Filed: Jan. 23, 2026

(30) Foreign Application Priority Data
Jan. 23, 2025 (CN) 202520166513.3

(51) Int. Cl. A61H 19/00

(52) U.S. Cl. CPC A61H 19/30; A61H 2201/0153; A61H 2201/0192; A61H 2201/1215; A61H 2201/14; A61H 2201/1418; A61H 2201/1669; A61H 2201/1676

(57) ABSTRACT

A sexual stimulation device and a sexual toy are provided. The sexual stimulation device includes a housing; a driving assembly accommodated in the housing, the driving assembly comprising a motor; a transmission structure comprising a first part accommodated in the accommodation cavity and coupled to the motor, the first part extending substantially along a first straight line in a case that the sexual stimulation device is in an initial state; and a massage assembly arranged with the housing along a first direction parallel to the first straight line, the massage assembly comprising a massage portion drivingly connected to the transmission structure. The massage portion is driven by the motor via the transmission structure to move reciprocated motion at least between a first state and a second state.

### CROSS-REFERENCE TO RELATED APPLICATIONS

The present application claims the benefit of and priority to Chinese Patent Application Serial No. 202520166513.3, entitled “VIBRATING MASSAGER”, filed with China National Intellectual Property Administration (CNIPA) on January 23, 2025. The entire contents of all of the above-mentioned applications are hereby incorporated herein fully by reference into the present disclosure.

### TECHNICAL FIELD

The present disclosure relates to the technical field of sexual stimulation, in particular to a sexual stimulation device and a sexual toy.

### BACKGROUND

With the development of technology, the types of sexual stimulation devices have become increasingly diverse. However, the existing sexual stimulation devices have a single function, and most of them adopting a telescopic mode for hammer pressing, which may be painful for some users.

### BRIEF DESCRIPTION OF DRAWINGS

In order to illustrate the technical solution in embodiments of the present disclosure more clearly, the following briefly introduces accompanying drawings used in the description of the embodiments. It should be noted that the accompanying drawings in the following descriptions cover only some embodiments of the present disclosure. Those of ordinary skill in the art may derive other drawings from these accompanying drawings without any creative efforts.

FIG. 1 is a three-dimensional structural diagram of a sexual stimulation device according to a first embodiment of the present disclosure.

FIG. 2 is a three-dimensional structural diagram of the sexual stimulation device shown in FIG. 1 from another angle.

FIG. 3 is a partial exploded view of the sexual stimulation device shown in FIG. 1.

FIG. 4 is a cross-sectional view of the sexual stimulation device shown in FIG. 1.

FIG. 5 is a three-dimensional structural diagram of a partial structure of the sexual stimulation device shown in FIG. 1.

FIG. 6 is a three-dimensional structural diagram of the partial structure of the sexual stimulation device shown in FIG. 5, viewed from another angle.

FIG. 7 is an exploded schematic diagram of the partial structure of the sexual stimulation device shown in FIG. 6.

FIG. 8 is an enlarged schematic diagram of region VIII in FIG. 7.

FIG. 9A is a perspective view of the sexual stimulation device shown in FIG. 1 in a first state.

FIG. 9B is a perspective view of the sexual stimulation device shown in FIG. 1 in a second state.

FIG. 10 is a three-dimensional structural diagram of a sexual stimulation device according to a second embodiment of the present disclosure.

FIG. 11A is a perspective view of the sexual stimulation device shown in FIG. 10 in a first state.

FIG. 11B is a perspective view of the sexual stimulation device shown in FIG. 10 in a second state.

FIG. 12 is a three-dimensional structural diagram of a sexual stimulation device according to a third embodiment of the present disclosure.

FIG. 13 is an exploded view of the sexual stimulation device shown in FIG. 12.

FIG. 14 is a three-dimensional structural diagram of a sexual toy according to a fourth embodiment of the present disclosure.

FIG. 15 is an exploded view of the sexual toy shown in FIG. 14.

FIG. 16 is a cross-sectional view of the sexual toy shown in FIG. 14.

### DETAILED DESCRIPTION

To make the purpose, technical solutions and advantages of the present disclosure clearer, the technical solutions in the embodiments of the present disclosure will be described in more detail hereinafter in conjunction with the drawings in preferred embodiments of the present disclosure. In the drawings, the same or similar reference numerals denote the same or similar components or components having the same or similar functions throughout. The described embodiments are a part of embodiments of the present disclosure, not all thereof. The embodiments described hereinafter by referring to the figures are exemplary, and are intended to explain the present disclosure, and should not be construed as limiting the present disclosure. Based on the embodiments in the present disclosure, all other embodiments obtained by those skilled in the art without creative efforts fall within the claimed scope of the present disclosure. Hereinafter, embodiments of the present disclosure will be described in detail in conjunction with the accompanying drawings.

In the description of the present disclosure, it should be noted that, unless otherwise clearly stipulated and limited, the terms “installed”, “connected with” and “connected” should be understood in a broad sense. For example, they can be fixedly connected, or indirectly connected through an intermediate medium, which can be the internal communication of two elements or the interaction relationship between two elements. For those skilled in the art, the concrete meaning of the above-mentioned terms in the present disclosure can be understood under concrete circumstances.

In the description of the present disclosure, it should be understood that the orientation or positional relationship indicated by the terms “upper”, “lower”, “front”, “rear”, “vertical”, “horizontal”, “top”, “bottom”, “inner”, “outer” is based on the orientation or positional relationship shown in the drawings, and is only for the convenience of describing the present disclosure and simplifying the description, rather than indicating or implying that the referred device or element must include a specific orientation, constructed and operated in a particular orientation and therefore should not be understood as limiting the present disclosure.

The terms “first”, “second”, and “third” (if any) in the description, claims and the above drawings of the present disclosure are used to distinguish similar objects and not necessarily to describe a specific order or priority. It should be understood that the data thus used are interchangeable under appropriate circumstances such that the embodiments of the present disclosure described herein can be practiced in sequences other than those illustrated or described herein.

Furthermore, the terms “comprise”/“include” and “include”, as well as any variations thereof, are intended to cover a non-exclusive inclusion, for example, a process, method, system, product or maintenance tool comprising a series of steps or units need not be limited to the expressly listed, but other steps or elements not explicitly listed or inherent to the process, method, product or maintenance tool may be included.

### First embodiment

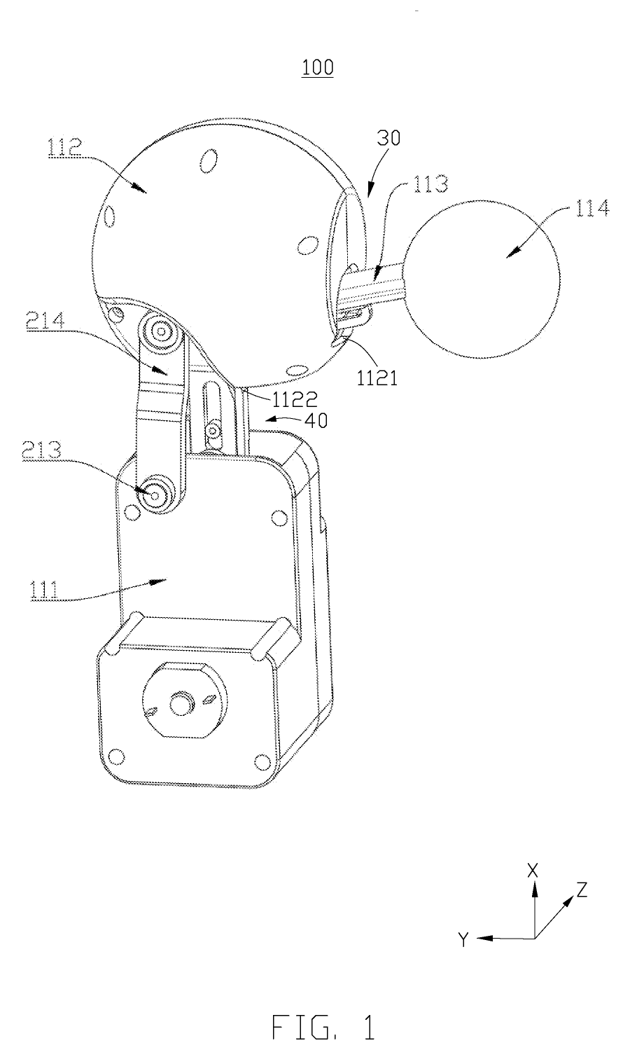

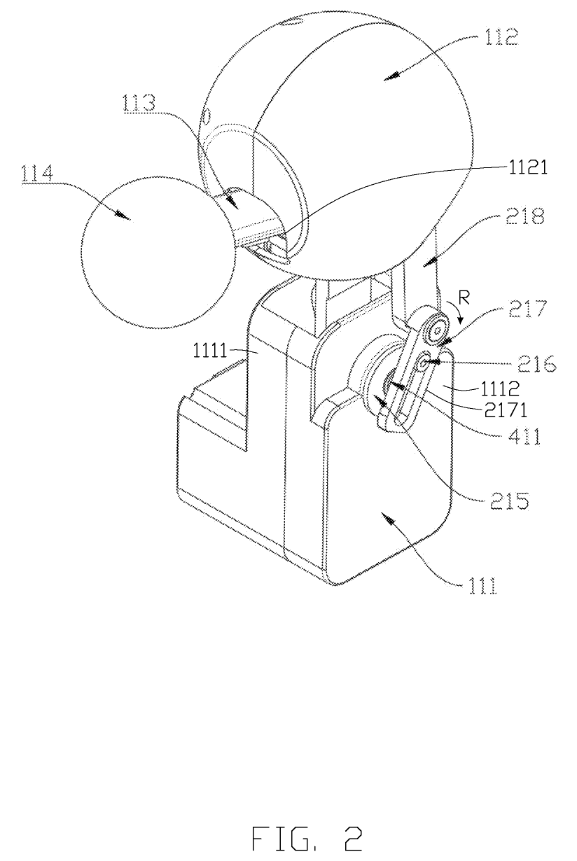

Referring to FIGS. 1-2, a first embodiment of the present disclosure provides a sexual stimulation device 100 configured to perform a licking massage action on a to-be-massaged portion of a female. In the present embodiment, the sexual stimulation device 100 is illustrated for massaging and stimulating a to-be-massaged part of a female, however, in other embodiments, the sexual stimulation device 100 may also be configured to perform licking massage on a to-be-massaged portion of a male.

For the convenience of the following description, the spatial directions of the sexual stimulation device 100 are defined as follows in the present embodiment. Referring to FIG. 1, a height direction of the sexual stimulation device 100 in a normal placement state is defined as a first direction X, a width direction of the sexual stimulation device 100 is defined as a second direction Y, and a depth direction of the sexual stimulation device 100 is defined as a third direction Z, the first direction X, the second direction Y and the third direction Z are perpendicular to each other pairwise.

The sexual stimulation device 100 includes a housing 111, a massage assembly 30, a transmission structure 40 and a driving assembly 50. The driving assembly 50 and at least a part of the transmission structure 40 are accommodated in the housing 111. The driving assembly 50 is configured to provide power, and the power output by the driving assembly 50 is transmitted to the massage assembly 30 via the transmission structure 40, so as to drive the massage assembly 30 to perform the licking massage action in a reciprocating manner.

In the present embodiment, the housing 111 is a substantially L-shaped columnar structure and defines an accommodation cavity 110, which is configured to accommodate the driving assembly 50 and the at least a part of the transmission structure 40. At least a part of the housing 111 functions as a handheld portion for a user to grip conveniently.

The housing 111 includes a first side wall 1111 and a second side wall 1112, which are oppositely disposed along the third direction Z. The first side wall 1111 is convexly provided with a fixed shaft 213 along the third direction Z and away from the second side wall 1112.

The massage assembly 30 is spaced from the housing 111 along the first direction X and connected thereto through the transmission structure 40. The massage assembly 30 includes a swinging portion 112, a connecting plate 113 and a massage portion 114, and the swinging portion 112 is disposed above the housing 111 at an interval. The swinging portion 112 defines a first opening 1121 and a second opening 1122, the first opening 1121 is defined on one side of the swinging portion 112 along the second direction Y for a telescopic movement of the connecting plate 113, and the second opening 1122 faces the housing 111 for the transmission structure 40 to pass through and move. In the present embodiment, the swinging portion 112 is substantially spherical, and the first opening 1121 is defined on one side of the swinging portion 112 (i.e., a right side of the swinging portion 112 in FIG. 1), and the second opening 1122 is formed on another side of the swinging portion 112 facing the housing 111 (i.e., a bottom side of the swinging portion 112 in FIG. 1).

In the present embodiment, an outer surface of the swinging portion 112 is covered with a flexible layer made of materials such as rubber or silicone, which can avoid discomfort to the human body caused by hard contact during use and enhance the use comfort.

One end of the connecting plate 113 is telescopically disposed in the first opening 1121 of the swinging portion 112 along the second direction Y and coupled to the transmission structure 40, and the other end of the connecting plate 113 is connected to the massage portion 114, so that the massage portion 114 can be driven to perform reciprocating upward hooking and downward swinging motions along the second direction Y under a driving action of the transmission structure 40.

In the present embodiment, an outer surface of the massage portion 114 is covered with a flexible layer to ensure comfort and safety during massage. The massage portion 114 performs circular swinging following the swinging portion 112 while telescopically sliding with the connecting plate 113, so as to cooperate with the swinging portion 112 to form the licking massage action, thereby improving a massage effect of the sexual stimulation device 100.

In other embodiments, the connecting plate 113 and the massage portion 114 may also be an integrated structure, referred to as the massage portion for short, which is not limited herein.

The transmission structure 40 includes a first transmission structure 41 and a second transmission structure 42; the first transmission structure 41 is coupled to the swinging portion 112 and configured to drive the swinging portion 112 to perform circular swinging, and the second transmission structure 42 is coupled to the massage assembly 30 and configured to drive the massage assembly 30 to perform telescopic sliding, and the first transmission structure 41 and the second transmission structure 42 move synchronously under the driving action of the driving assembly 50, so as to the massage assembly 30 to perform the licking massage action in a reciprocating manner.

Referring to FIG. 1 and FIG. 2, the first transmission structure 41 includes a rotating shaft 411, the fixed shaft 213, a fixed wheel 215, a first rod member 214, a second rod member 217 and a third rod member 218.

Referring to FIG. 1, one end of the first rod member 214 is rotatably connected to the first fixed shaft 213, and the other end of the first rod member 214 is rotatably connected to a bottom end of the swinging portion 112.

The rotating shaft 411 penetrates the second side wall 1112 of the housing 111 along the third direction Y. One end of the rotating shaft 411 is coupled to the fixed wheel 215, and the other end of the rotating shaft 411 is coupled to the second transmission structure 42.

Referring to FIG. 2, a limit shaft 216 is eccentrically disposed on the fixed wheel 215, a limit groove 2171 adapted to the limit shaft 216 is defined at one end of the second rod member 217, and the limit shaft 216 is embedded in the limit groove 2171 to achieve sliding limit. The other end of the second rod member 217 is drivingly connected to the third rod member 218, and the end of the third rod member 218 away from the second rod member 217 is rotatably connected to the swinging portion 112. The third rod member 218 and the first rod member 214 are located on opposite sides of the swinging portion 112 along the third direction Z.

Thus, when the rotating shaft 411 rotates clockwise (R), the eccentrically disposed limit shaft 216 on the fixed wheel 215 rotates clockwise, which can make the second rod member 217 and the third rod member 218 drive the swinging portion 112 to swing back and forth in a circular manner, specifically moving along a motion track of forward extending and upward hooking, and the first rod member 214 performs pitching deflection with the fixed shaft 213 as the axis to realize the circular swinging process of the swinging portion 112.

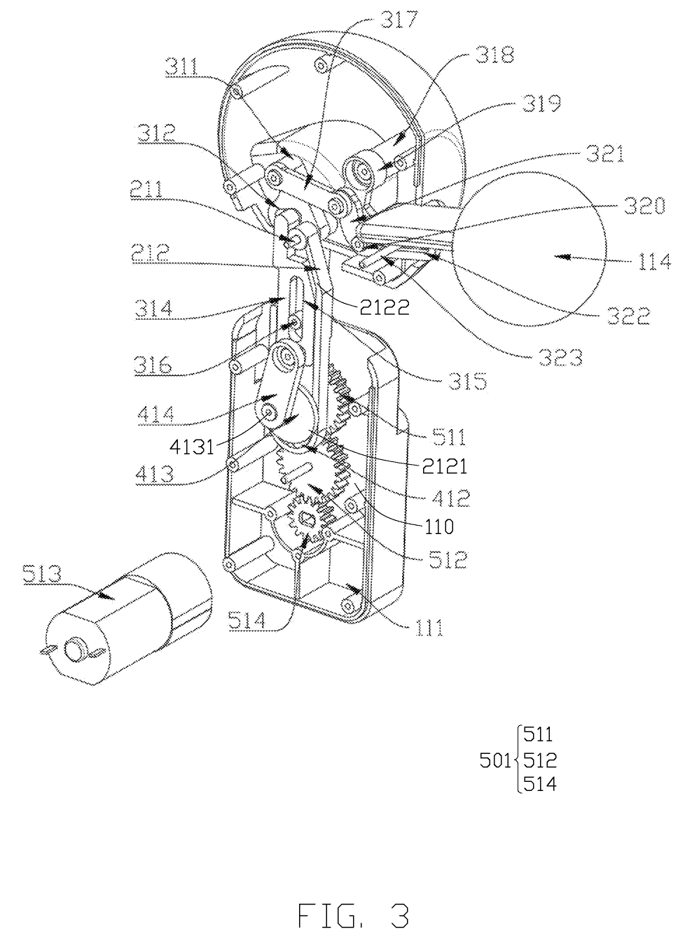

Referring to FIG. 3, the second transmission structure 42 includes a support shaft 211, a swinging frame 212, a triangular plate 311, a driving plate 314, a dual-cam transmission assembly 421 and a crank-link assembly 423. The support shaft 211 is disposed on an inner wall of the bottom of the swinging portion 112, one end of the swinging frame 212 is coaxially arranged with the triangular plate 311 and both are rotatably mounted on the support shaft 211, and the other end of the swinging frame 212 extends into the housing 111 and defines a through hole 2121. A mounting groove 2122 is defined on the surface of one side of the swinging frame 212, and the mounting groove 2122 is configured to accommodate the driving plate 314. A first transmission shaft 316 is convexly disposed in the mounting groove 2122.

The driving plate 314 is disposed in the mounting groove 2122 of the swinging frame 212, and a limit groove 315 is defined on the driving plate 314 and configured to accommodate the first transmission shaft 316, so as to limit the swinging frame 212 from sliding along the limit groove 315. A second transmission shaft 313 is disposed at the end of the driving plate 314 close to the triangular plate 311, a transverse groove 312 is formed on the triangular plate 311, and the second transmission shaft 313 is embedded in the transverse groove 312 to realize limit sliding.

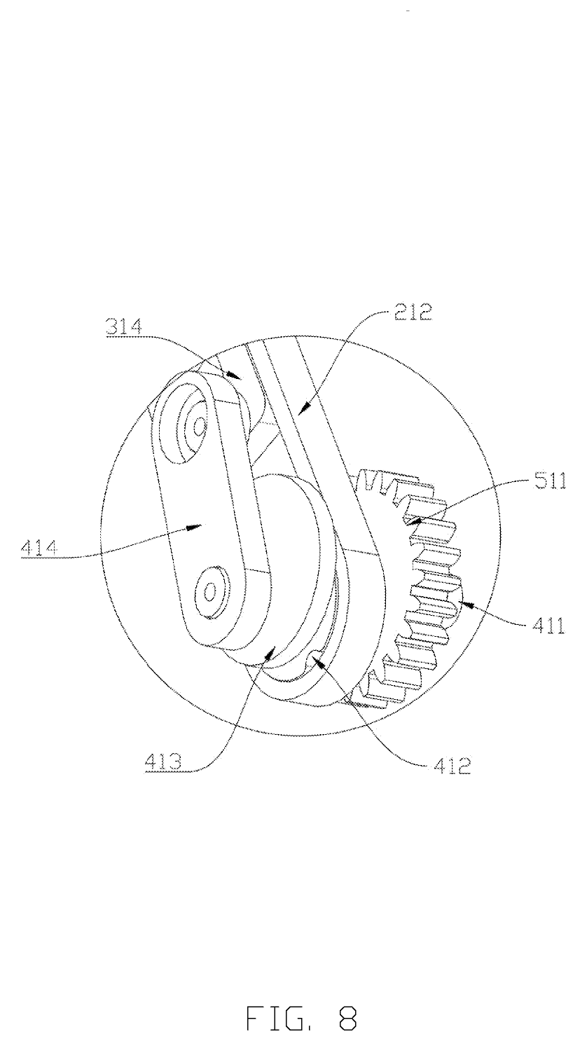

Referring to FIG. 3 to FIG. 4 and FIG. 6 to FIG. 8, the dual-cam transmission assembly 421 is configured to drive the swinging frame 212 to swing and drive the driving plate to slide along the third direction Z at the same time. The dual-cam transmission assembly 421 includes a first eccentric wheel 412 and a second eccentric wheel 413 which are eccentrically disposed. The first eccentric wheel 412 is accommodated in the through hole 2121 of the swinging frame 212 and eccentrically and fixedly connected to the rotating shaft 411, and the second eccentric wheel 413 is drivingly connected to the first eccentric wheel 412. A second mounting shaft 4131 is disposed at the end of the second eccentric wheel 413 away from the first eccentric wheel 412. One end of a driving rod 414 is rotatably connected to the second mounting shaft 4131, and the other end of a driving rod 414 is rotatably connected to the lower part of the driving plate 314.

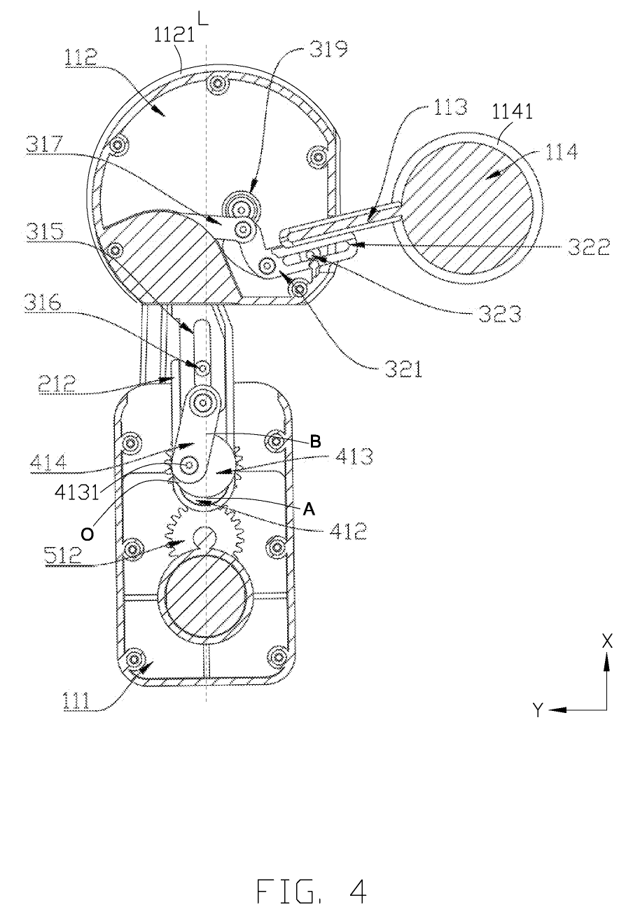

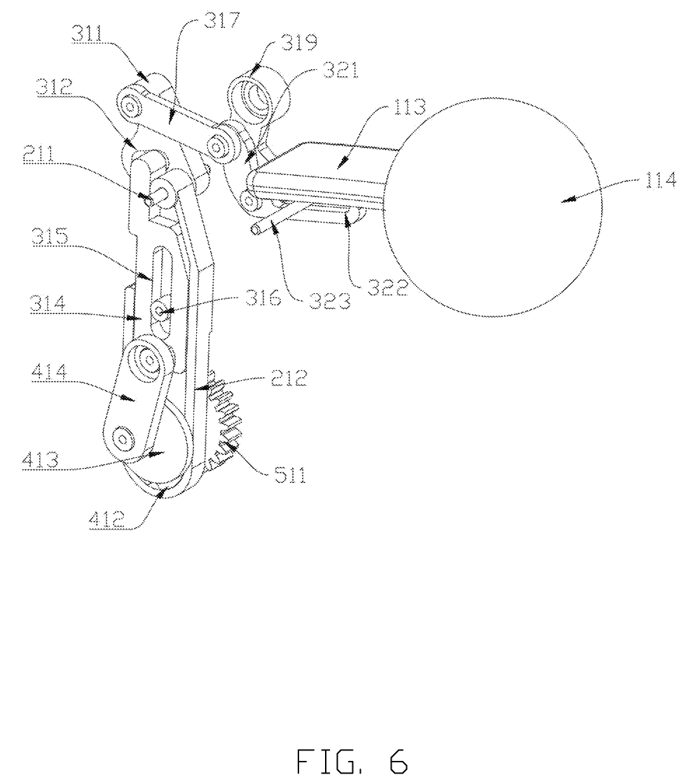

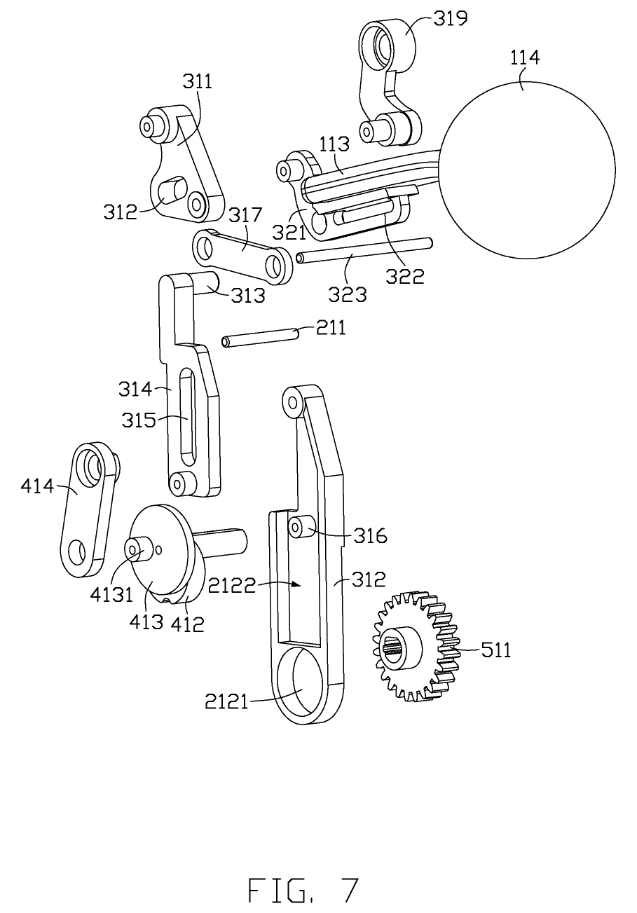

Since the rotating shaft 411 is eccentrically and fixedly connected to the first eccentric wheel 412, the second eccentric wheel 413 is drivingly connected to the first eccentric wheel 412, one end of the driving rod 414 is rotatably connected to the second eccentric wheel 413 through the second mounting shaft 4131 of the second eccentric wheel 413, and the other end of the driving rod 414 is rotatably connected to the driving plate 314, and the first eccentric wheel 412 is disposed at the lower part of the swinging frame 212. Therefore, when the rotating shaft 411 rotates counterclockwise as shown in FIG. 3, FIG. 6 and FIG. 7, and the convex end of the second eccentric wheel 413 is at the position shown in FIG. 3 and FIG. 4 and continues to rotate counterclockwise as shown in FIG. 3, a series of linkage actions are triggered synchronously. The limit shaft 216 of the first link transmission structure rotates clockwise as shown in FIG. 2 and drives the second rod member 217 to deflect to realize the upward hooking process of the swinging portion 112, and the second mounting shaft 4131 of the first eccentric wheel 412 continues to slide counterclockwise upward from the left-offset position in FIG. 4 to adapt to the upward hooking process of the swinging portion 112. At the same time, the second eccentric wheel 413 drives the driving plate 314 to retract downward through the driving rod 414 to complete the upward hooking sliding process of the massage portion. Similarly, with the continuous rotation of the rotating shaft 411, the swinging portion 112 repeatedly performs forward extending and upward hooking, and the massage portion synchronously performs downward swinging and upward hooking, so as to realize the process that the massage portion simulates an upward kneading operation.

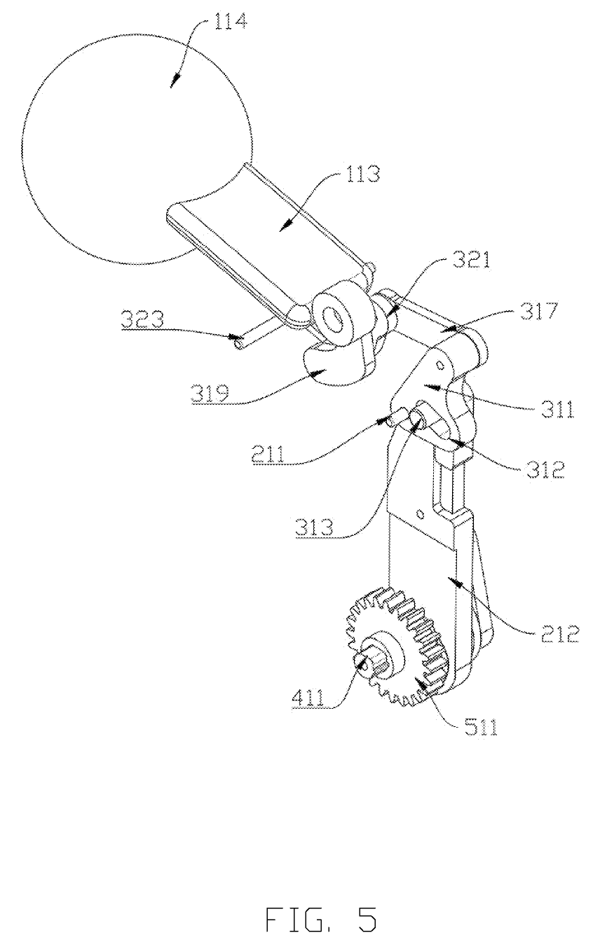

Referring to FIG. 5 to FIG. 7, the crank-link assembly 423 includes a first connecting shaft 318, a connecting plate 319, a second connecting shaft 320, a V-shaped rod 321, a connecting rod 317, a support member 323 and a chute 322. The first connecting shaft 318 is disposed on the inner wall of the swinging portion 112 and close to the first opening 1121. One end of the connecting plate 319 is rotatably mounted on the first connecting shaft 318, and the second connecting shaft 320 is disposed at the other end of the connecting plate 319. The V-shaped rod 321 is mounted on the second connecting shaft 320 and rotatable therearound. One end of the V-shaped rod 321 is fixed to the connecting plate 113, and the other end of the V-shaped rod 321 is rotatably connected to the connecting rod 317. The end of the connecting rod 317 away from the V-shaped rod 321 is rotatably connected to the end of the triangular plate 311. The support member 323 is fixed to the lower part of the front wall of the swinging portion 112. The chute 322 is formed at the end of the V-shaped rod 321 close to the connecting plate 113, and the support member 323 is embedded in the chute 322 to realize limit sliding.

In the present embodiment, the V-shaped rod 321 takes the second connecting shaft 320 at the end of the connecting plate 319 as the rotation center, one end of the V-shaped rod 321 is rotatably connected to the top of the triangular plate 311 through the connecting rod 317, and the other end of the V-shaped rod 321 is fixedly connected to the connecting plate 113. Therefore, when the driving plate 314 pulls the triangular plate 311 to deflect around the support shaft 211, the V-shaped rod 321 is synchronously driven to deflect clockwise or counterclockwise correspondingly around the second connecting shaft 320. Specifically, referring to FIG. 3, when the driving plate 314 contracts downward and the triangular plate 311 deflects counterclockwise, the connecting rod 317 pulls the V-shaped rod 321 to rotate counterclockwise around the second connecting shaft 320, thereby driving the connecting plate 113 at the end of the V-shaped rod 321 and the massage portion 114 to lift upward, and to swing downward in the opposite case. In addition, the support member 323 is mounted with the chute 322 on the V-shaped rod 321 in a limit fit manner. referring to FIG. 3 and FIG. 4, the structural arrangement can not only ensure that the massage portion completes the movement processes of telescoping, lifting upward and swinging downward, but also effectively ensure the movement stability of the massage portion 114 where the massage portion is located.

Further, the transmission structure 40 may also include a first part, a second part and a third part. The first part includes a part of the second transmission structure 42 disposed along the first direction X, i.e., the support shaft 211, the swinging frame 212, the triangular plate 311, the driving plate 314 and the dual-cam transmission assembly 421. The second part includes the first transmission structure 41. The third part includes the other part of the second transmission structure 42, i.e., the crank-link assembly 423. In the initial state of the sexual stimulation device 100 as shown in FIG. 1, the first part extends substantially along a first straight line L, and the first straight line L is parallel to the first direction X.

Referring to FIG. 3, the driving assembly 50 includes a motor 513 and a driving gear group 501. The motor 513 is fixedly mounted in a motor mounting position at the lower part of the housing 111, serving as the power source of the entire device. an output end of the motor 513 is coupled to the driving gear group 501, so that the start, stop and massage intensity adjustment of the massage motion are realized through the start-stop and rotational speed adjustment of the motor 513.

The driving gear group 501 includes a first transmission gear 511, a second transmission gear 512 and a driving gear 514. The first transmission gear 511 is fixed on the rotating shaft 411 and rotates synchronously with the rotating shaft 411. The second transmission gear 512 is rotatably connected to the housing 111 through a shaft arranged inside the housing 111, one side of which meshes with the first transmission gear 511 and the other side meshes with the driving gear 514, playing a role in power transmission and direction changing. The driving gear 514 is fixed on the output end of the motor 513 and rotates synchronously with the output shaft of the motor 513, transmitting the power of the motor to the second transmission gear 512.

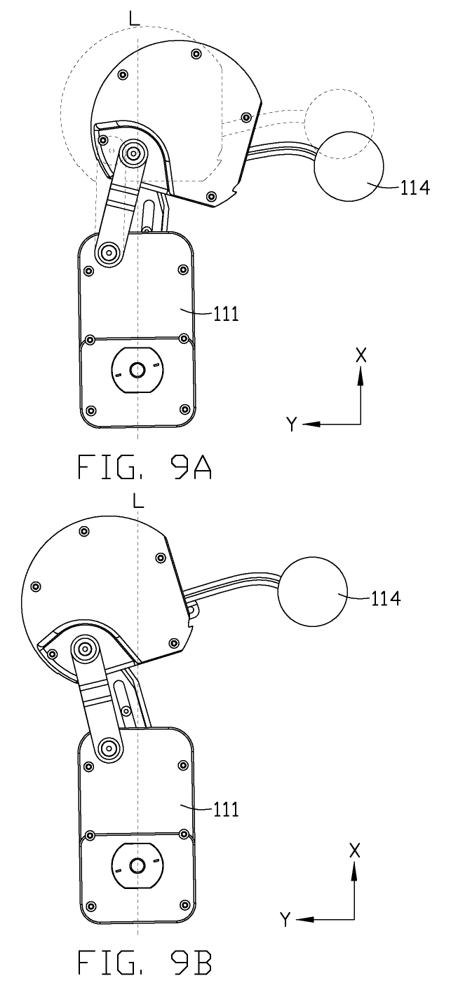

Referring to FIG. 9A and FIG. 9B, after the motor 513 is started and outputs rotational power, which is transmitted to the second transmission gear 512 through the driving gear 514, and then the second transmission gear 512 transmits the power to the first transmission gear 511 to drive the rotating shaft 411 to rotate. When the rotating shaft 411 rotates and drives the second transmission structure 42 to act, the fixed shaft 213 drives the first rod member 214 to pitch and deflect, the limit shaft 216 on the fixed wheel 215 performs a circular motion, and the swinging portion 112 is pulled to swing circularly along the track of forward extending - upward hooking through the second rod member 217 and the third rod member 218. On the other hand, the rotating shaft 411 drives the dual-cam transmission assembly 421 of the first transmission structure 41 to act, the first eccentric wheel 412 drives the swinging frame 212 to deflect with the support shaft 211 as the axis, the second eccentric wheel 413 pulls the driving plate 314 to slide longitudinally in the swinging frame 212 through the driving rod 414, the driving plate 314 pushes the triangular plate 311 to deflect through the second transmission shaft 313, and the triangular plate 311 pulls the V-shaped rod 321 to rotate through the crank-link assembly 423, thereby driving the connecting plate 113 and the massage portion 114 to swing downward and hook upward.

Referring to FIG. 2 and FIG. 4, the sexual stimulation massage device 100 of the present embodiment is in an initial state, the first part of the transmission structure 40 extends along the first straight line L, the second mounting shaft 4131 is located at the left side of the second eccentric wheel 413, i.e., position O, and the sliding rod 323 is located at approximately the middle position of the sliding groove 322. After the motor 513 is started, the power of the motor 513 is transmitted to the massage assembly 30 through the transmission structure 40, enabling the massage assembly 30 to move reciprocated motion at least between a first state and a second state. The following description is given by taking the rotation of the rotating shaft 411 along the rotation direction R as an example.

When the rotating shaft 411 rotates along the rotation direction R, in the first state, the second mounting shaft 4131 of the second eccentric wheel 413 rotates synchronously along the rotation direction R. During the rotation from position O to position A, the transmission plate 314 is driven to move downward by the drive rod 414, which in turn pushes the triangular plate 311 to rotate counterclockwise. The connecting rod 317 pulls the V-shaped rod 321 to rotate counterclockwise around the second connecting shaft 320, thereby driving the connecting plate 113 at the end of the V-shaped rod 321 and the massage portion 114 to move downward. At this time, the massage portion 114 retracts relative to the swinging portion 112, and at the same time, the limit shaft 216 rotates along the rotation direction R in FIG. 2 and drives the second rod member 217 to deflect, realizing the downward movement of the swinging portion 112.

Further, after entering the second state, the second mounting shaft 4131 of the second eccentric wheel 413 continues to rotate along the rotation direction R. During the rotation from position A to position B, the transmission plate 314 is pushed upward by the drive rod 414, which in turn pushes the triangular plate 311 to rotate clockwise. The connecting rod 317 pulls the V-shaped rod 321 to rotate clockwise around the second connecting shaft 320, thereby driving the connecting plate 113 at the end of the V-shaped rod 321 and the massage head body 114 to lift upward. At this time, the massage portion 114 extends relative to the swinging portion 112, and at the same time, the limit shaft 216 continues to rotate along the rotation direction R in FIG. 2 and drives the second rod member 217 to deflect, realizing the upward lifting of the swinging portion 112.

In addition, in the first state, referring to FIG. 9A, the massage portion 114 approaches the housing 111 along the first direction X and is away from the first straight line L along the second direction Y perpendicular to the first direction X. In the second state, referring to FIG. 9B, the massage portion 114 is away from the housing 111 along the first direction X and approaches the first straight line L along the second direction Y. Through the above reciprocating motion, the massage portion 114 can realize licking massage on the to-be-massaged part of the human body, thereby achieving a better stimulation effect.

### Second Embodiment

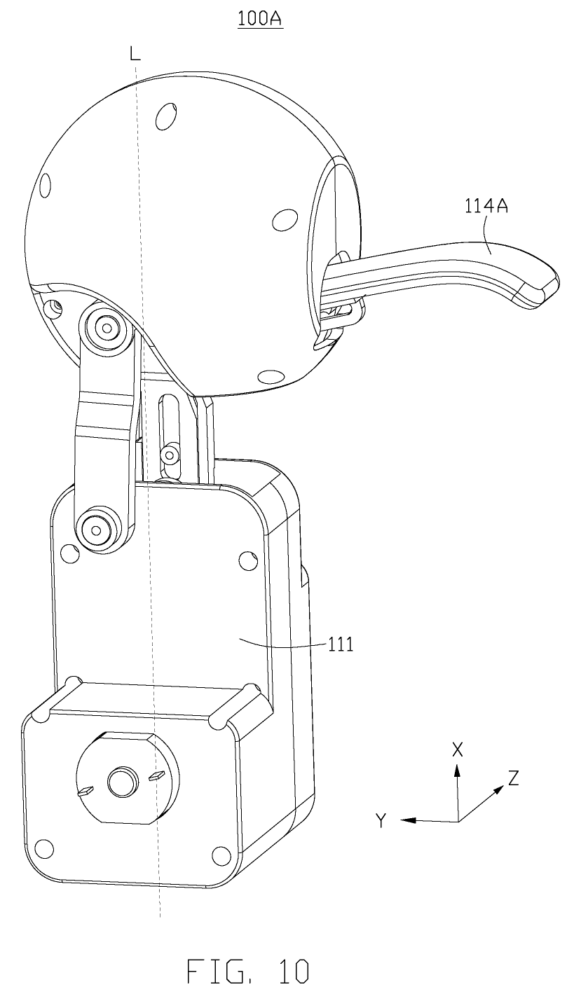

Referring to FIG. 10, a sexual stimulation device 100A according to a second embodiment of the present disclosure is different from the sexual stimulation device 100 according to the first embodiment in that the structure of a massage portion 114A of the sexual stimulation device 100A is different from that of the massage portion 114 of the sexual stimulation device 100.

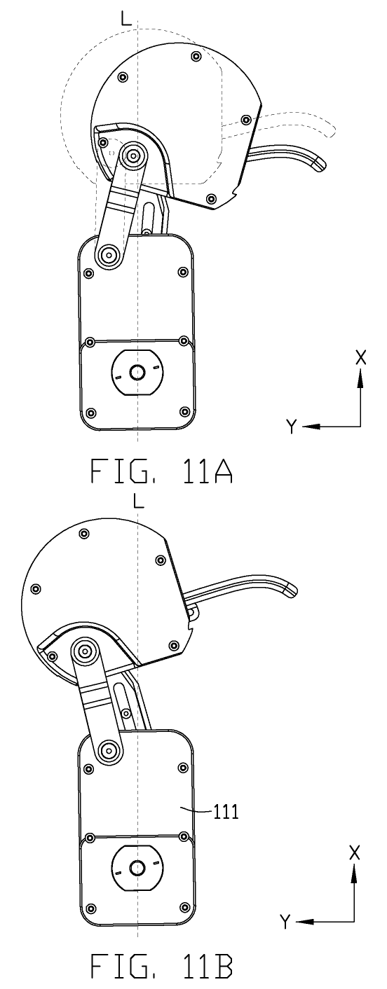

In the present embodiment, the massage portion 114A includes a tongue-shaped structure imitating the human tongue. Referring to FIG. 11A and FIG. 11B, the structure of the massage portion 114A can realize contoured close fitting with the human tongue, effectively increase the massage contact area and improve the contact fitting degree, and at the same time avoid the problem of local stress concentration during massage, thereby forming more accurate targeted stimulation on the to-be-massaged part of the human body and significantly optimizing the stimulation effect and use experience of massage.

### Third Embodiment

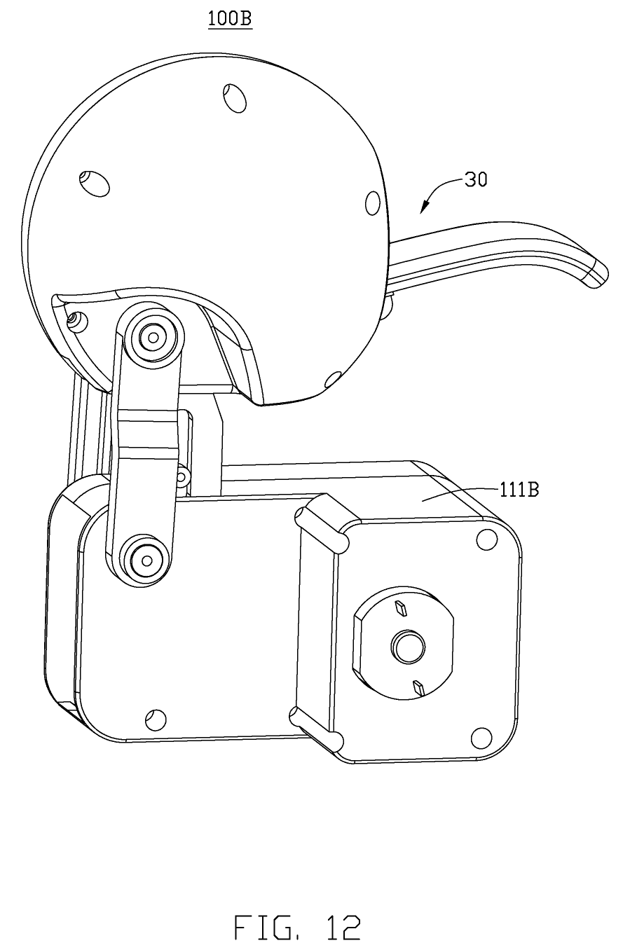

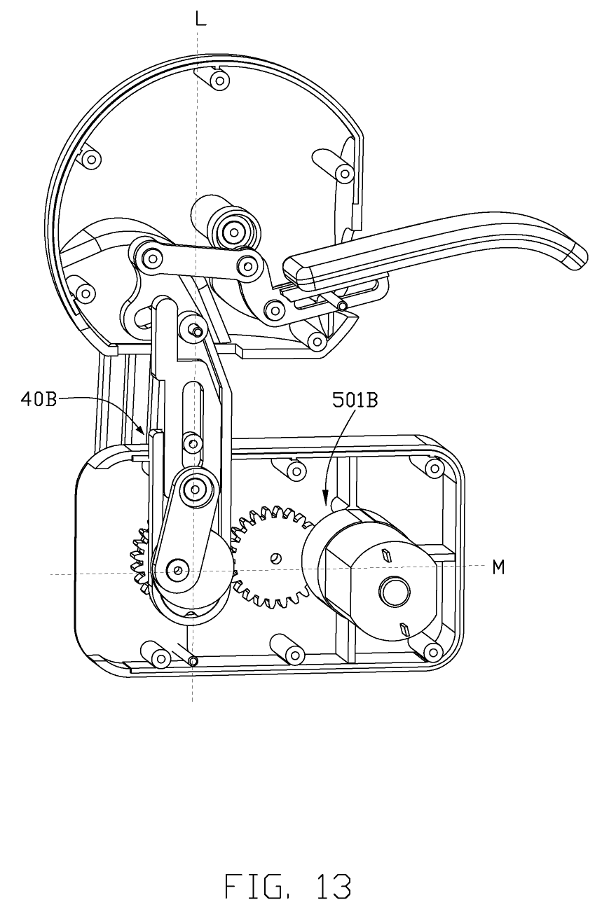

Referring to FIG. 12 and FIG. 13, the difference between a sexual stimulation device 100B according to a third embodiment of the present disclosure and the sexual stimulation device 100 according to the first embodiment is as follows. First, a structure of the housing 111B of the sexual stimulation massage device 100B in the present embodiment is different from that of the housing 111 of the sexual stimulation massage device 100A, and an arrangement mode of the transmission structure 40B and the driving assembly 50B of the sexual stimulation massage device 100B is different from that of the transmission structure 40 and the driving assembly 50 of the sexual stimulation massage device 100A.

In the present embodiment, an extending direction L of the first part of the transmission structure 40B is substantially perpendicular to an extending direction M of the driving gear group 501B in the driving assembly 50B, and accordingly, the structural composition of the housing 111B is also different from that of the housing 111 of the sexual stimulation massage device 100A.

### Fourth Embodiment

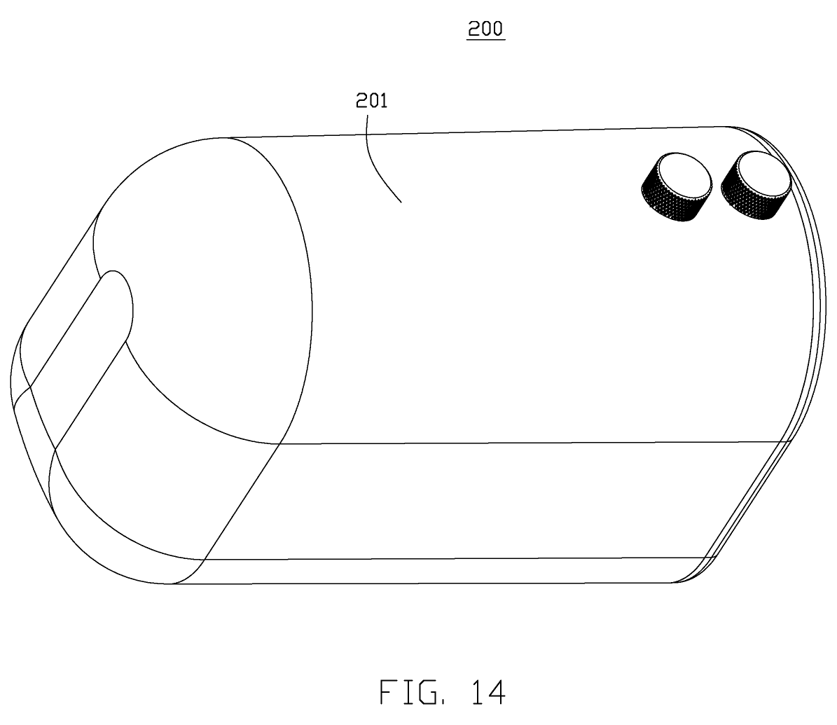

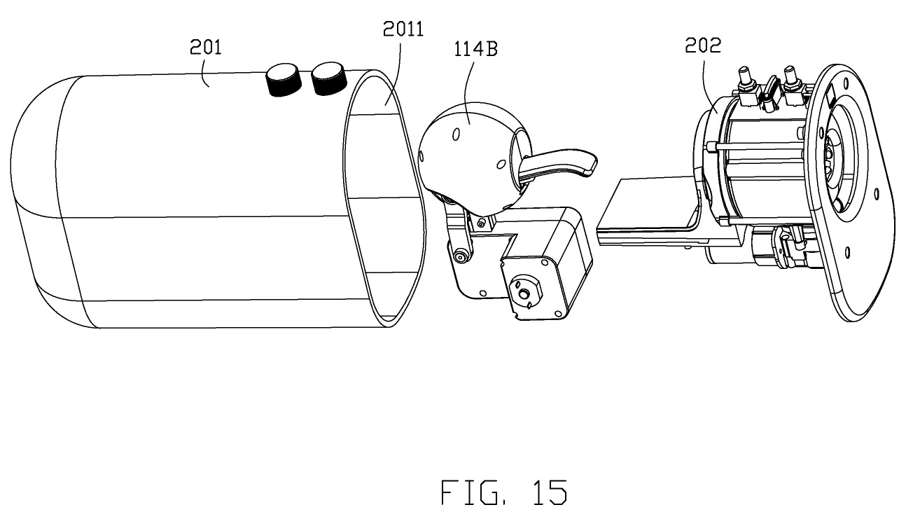

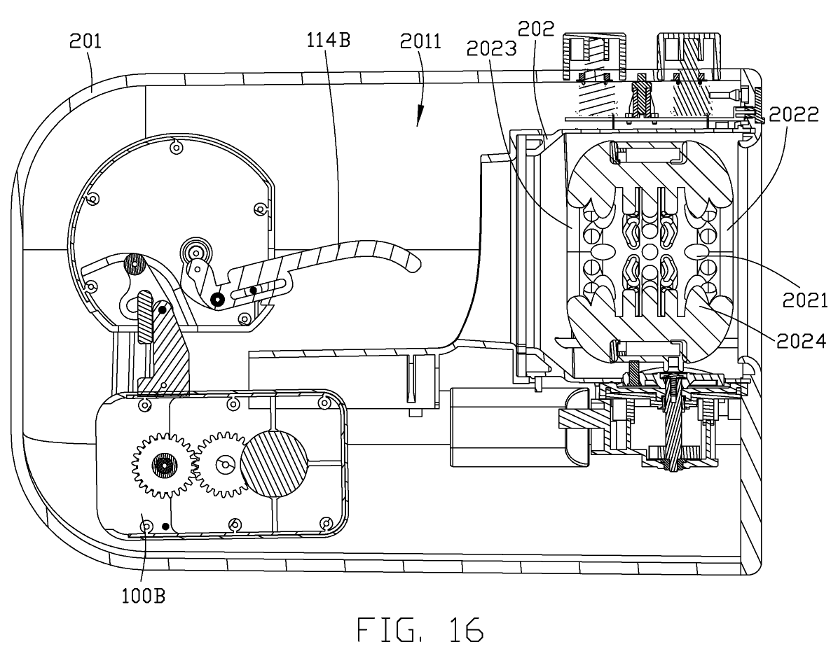

Referring to FIG. 14 to FIG. 16, the present embodiment provides a sexual stimulation device 200 configured to stimulate the to-be-massaged portion of a male. The sexual stimulation device 200 includes a casing 201, a main body 202 and the sexual stimulation massage device 100B according to the third embodiment. The casing 201 includes a receiving cavity 2011, and both the main body 202 and the sexual stimulation massage device 100B are accommodated in the receiving cavity 2011. The main body 202 defines a channel 2021, which is allow the to-be-massaged portion of a male to insert and is in communication with the receiving cavity 2011. The channel 2021 is hollow and extends from an outer side 2022 of the main body 202 to an inner side 2023 of the main body 202, such that the to-be-massaged portion is insertable into the receiving cavity 2011 via the channel 2021. In addition, the main body 202 further includes a plurality of stimulation portion 2024 arranged on the side wall surrounding the channel 2021, and the plurality of stimulation portion 2024 is configured for stimulating a first region of the to-be-massaged portion.

The sexual stimulation massage device 100B is accommodated in the receiving cavity 2011, and a massage portion 114B thereof is disposed on adjacent to the inner side 2023 of the main body 202 and faces the channel 2021 so as to stimulate a second region of the to-be-massaged portion.

What is claimed is:

1. A sexual stimulation device, comprising:
a housing comprising a handheld portion and defining an accommodation cavity;
a driving assembly accommodated in the accommodation cavity of the housing, the driving assembly comprising a motor;
a transmission structure comprising a first part accommodated in the accommodation cavity and coupled to the motor, the first part extending substantially along a first straight line in a case that the sexual stimulation device is in an initial state; and
a massage assembly arranged with the housing along a first direction parallel to the first straight line, the massage assembly comprising a massage portion drivingly connected to the transmission structure,
wherein the massage portion is driven by the motor via the transmission structure to move reciprocated motion at least between a first state and a second state, in the first state, the massage portion approaches the housing along the first direction and is away from the first straight line along a second direction perpendicular to the first direction; in the second state, the massage portion moves away from the housing along the first direction and approaches the first straight line along the second direction.

2. The sexual stimulation device according to claim 1, wherein the massage assembly further comprises a swinging portion arranged with the housing along the first direction, the swinging portion defining a first opening, and at least a part of the massage portion is telescopically accommodated in the first opening.

3. The sexual stimulation device according to claim 2, wherein the transmission structure further comprises a second part coupled to the housing and the swinging portion, and the second part is configured to drive the swinging portion to swing reciprocatedly along a circular preset track.

4. The sexual stimulation device according to claim 3, wherein the housing comprises a first side wall and a second side wall opposite to the first side wall along a third direction, the third direction is perpendicular to the first direction and the second direction;
the second part comprises a first fixed shaft, a rotating shaft, a limiting shaft, a fixed wheel, a first rod member, a second rod member and a third rod member; wherein
the first fixed shaft is fixedly disposed on the first side wall;
one end of the first rod member is rotatably connected to the first fixed shaft, and another end of the first rod member is rotatably connected to the swinging portion;
the rotating shaft penetrates the second side wall along the third direction, one end of the rotating shaft is connected to the fixed wheel, and another end is connected to the transmission structure;
the limit shaft is eccentrically disposed on the fixed wheel;
one end of the second rod member defines a limit groove configured to receive the limit shaft, the limit shaft is embedded in the limit groove, and another end of the second rod member is connected to the third rod member;
an end of the third rod member away from the second rod member is rotatably connected to the swinging portion; the third rod member and the first rod member are respectively connected to opposite sides of the swinging portion along the third direction.

5. The sexual stimulation device according to claim 4, wherein the first part of the transmission structure comprises a support shaft, a swinging frame, a triangular plate, a driving plate and a dual-cam transmission assembly; wherein
the support shaft is disposed on an inner wall of the swinging portion at an side of the swing portion close to the housing, one end of the swinging frame and one end of the triangular plate are rotatably mounted on the support shaft, and another end of the swinging frame extends into the housing and is connected to the dual-cam transmission assembly;
the swinging frame defines a mounting groove, and the driving plate is disposed in the mounting groove.

6. The sexual stimulation device according to claim 5, wherein the swinging frame further defines a through hole at the other end of the swinging frame;
the dual-cam transmission assembly comprises a first eccentric wheel and a second eccentric wheel; wherein
the first eccentric wheel is accommodated in the through hole of the swinging frame and is eccentrically and fixedly connected to the rotating shaft, the second eccentric wheel is connected to the first eccentric wheel;
the transmission structure further comprises a second mounting shaft disposed on a side of the second eccentric wheel away from the first eccentric wheel, and a driving rod rotatably mounted on the second mounting shaft, wherein an end of the driving rod away from the second mounting shaft is rotatably connected to the driving plate.

7. The sexual stimulation device according to claim 5, wherein the transmission structure further comprises a third part comprising a first connecting shaft, a connecting plate, a second connecting shaft, a V-shaped rod and a connecting rod, wherein
the first connecting shaft is fixed on the inner wall of the swinging portion, and the connecting plate is rotatably mounted on the first connecting shaft;
the second connecting shaft is disposed at an end of the connecting plate away from the first connecting shaft, the V-shaped rod is mounted on the second connecting shaft and is rotatable around the second connecting shaft; one end of the V-shaped rod is fixed to an end of massage portion , and another end of the V-shaped rod is rotatably connected to the connecting rod; an end of the connecting rod away from the V-shaped rod is rotatably connected to the triangular plate.

8. The sexual stimulation device according to claim 7, wherein the third part further comprises a support member and a chute, wherein the support member is fixed on the inner wall of the swinging portion, the chute is defined at the end of the V-shaped rod fixed to the end of massage portion , and the support member is embedded in the chute and limits [the massage portion] from sliding along the support member.

9. The sexual stimulation device according to claim 5, further comprising a first transmission shaft convexly disposed in the mounting groove of the swinging frame, wherein the driving plate defines a limit groove, and the first transmission shaft is accommodated in the limit groove of the driving plate and limits the swinging frame from sliding along the limit groove.

10. The sexual stimulation device according to claim 4, wherein the housing comprises a shaft arranged an inner wall of the housing, the driving assembly further comprises a meshing driving assembly comprising a first transmission gear, a second transmission gear and a driving gear, wherein the driving gear is fixed on an output end of the motor, the first transmission gear is coupled to the rotating shaft, the second transmission gear is rotatably connected to the housing via the shaft, one side of the second transmission gear is meshed with the first transmission gear, and another side of the second transmission gear is meshed with the driving gear, so as to transmit driving power of the motor to the transmission structure.

11. The sexual stimulation device according to claim 1, wherein the massage portion comprises a flexible layer on an out surface of the massage portion.

12. A sexual stimulation device comprising:
a housing defining an accommodation cavity;
a driving assembly accommodated in the accommodation cavity of the housing;
a transmission structure comprising a first transmission structure and a second transmission structure, wherein the first transmission structure is on the housing, a part of the second transmission structure is accommodated in the accommodation cavity, the first transmission structure and the second transmission structure are driven by the driving assembly to move synchronously;
a swinging portion spaced from the housing along a first direction and coupled to the first transmission structure, the swinging portion is driven by the driving assembly through the first transmission structure to swing circularly along a preset track;
a massage portion coupled to the second transmission structure, wherein a part of the massage portion is telescopically accommodated in the swinging portion, the massage portion is driven by the driving assembly through the second transmission structure to reciprocatedly and telescopically slide and simultaneously follow the swinging portion to swing reciprocatedly along the preset track.

13. The sexual stimulation device according to claim 12, wherein the swinging portion is coupled to the housing via the transmission structure,
the swinging portion comprises a first opening and a second opening, wherein the first opening is defined on one side of the swinging portion along a second direction and configured for the massage portion to pass through to move telescopically movement, the second direction is substantially perpendicular to the first direction, and the second opening faces the housing such that the transmission structure to pass through the second opening to move.

14. The sexual stimulation device according to claim 12, wherein the housing comprises a first side wall and a second side wall oppositely arranged along a third direction, the third direction is perpendicular to the first direction;
the first transmission structure comprises a first fixed shaft, a rotating shaft, a fixed wheel, a first rod member, a second rod member and a third rod member, wherein
the first fixed shaft is disposed on the first side wall;
one end of the first rod member is rotatably connected to the first fixed shaft, and another end of the first rod member is rotatably connected to the swinging portion;
the rotating shaft penetrates the second side wall along the third direction, one end of the rotating shaft is connected to the fixed wheel, and another end of the rotating shaft is connected to the transmission structure;
the fixed wheel comprises a limit shaft eccentrically disposed on the fixed wheel;
one end of the second rod member defines a limit groove configured to receive the limit shaft, the limit shaft is embedded in the limit groove, and another end of the second rod member is connected to the third rod member;
an end of the third rod member away from the second rod member is rotatably coupled to the swinging portion;
the third rod member and the first rod member are respectively arranged on opposite sides of the swinging portion along the third direction.

15. The sexual stimulation device according to claim 14, wherein the second transmission structure comprises a support shaft, a swinging frame, a triangular plate, a driving plate, a dual-cam transmission assembly and a crank-link assembly, wherein
the support shaft is disposed on an inner wall of the swinging portion at a side of the swing portion close to the housing, one end of the swinging frame and the triangular plate are coaxially arranged and rotatably mounted on the support shaft, and another end of the swinging frame extends into the housing and is coupled to the dual-cam transmission assembly;
a mounting groove is defined on one side of the swinging frame, and the driving plate is disposed in the mounting groove.

16. The sexual stimulation device according to claim 15, wherein the driving plate defines a limit groove, the limit shaft is accommodated in the limit groove of the driving plate and configured to limit sliding movements in the limit groove.

17. The sexual stimulation device according to claim 15, wherein the other end of the swinging frame defines a through hole;
the dual-cam transmission assembly comprises a first eccentric wheel and a second eccentric wheel, wherein
the first eccentric wheel is accommodated in the through hole of the swinging frame and is eccentrically and fixedly connected to the rotating shaft,
the second eccentric wheel is connected to the first eccentric wheel;
a second mounting shaft is disposed at a side of the second eccentric wheel away from the first eccentric wheel, a driving rod is rotatably mounted on the second mounting shaft, and an end of the driving rod away from the second mounting shaft is rotatably connected to the driving plate.

18. The sexual stimulation device according to claim 15, wherein a second transmission shaft is fixed to an end of the driving plate close to the triangular plate, the triangular plate defines a transverse groove, and the second transmission shaft is embedded in the transverse groove and is configured to limit sliding movements in the transverse groove.

19. The sexual stimulation device according to claim 15, wherein the crank-link assembly comprises a first connecting shaft, a connecting plate, a second connecting shaft, a V-shaped rod and a connecting rod;
the first connecting shaft is fixed on the inner wall of the swinging portion, and the connecting plate is rotatably mounted on the first connecting shaft;
the second connecting shaft is disposed at an end of the connecting plate away from the first connecting shaft,
the V-shaped rod is mounted on the second connecting shaft and is rotatable around the second connecting shaft; one end of the V-shaped rod is fixed to an end of massage portion, and another end of the V-shaped rod is rotatably connected to the connecting rod;
an end of the connecting rod away from the V-shaped rod is rotatably connected to the triangular plate;
the crank-link assembly further comprises a support member and a chute, the support member is fixed on the inner wall of the swinging portion, the chute is defined at the end of the V-shaped rod fixed to the end of massage portion, and the support member is embedded in the chute and is configured to limit sliding movements in the chute.

20. A sexual toy comprising:
a casing comprising a receiving cavity;
a main body arranged in receiving cavity, the main body comprising a channel configured to receive a to-be-massaged portion and in air communication with the receiving cavity, wherein the channel is hollow and extends from an outer side of the main body to an inner side of the main body, the receiving cavity receives the to-be-massaged portion via the channel; and
a sexual stimulation device according to claim 1 arranged in the receiving cavity,
wherein the massage portion of the sexual stimulation device is adjacent to the inner side of the main body and faces the channel, the massage portion is configured to massage the to-be-massaged portion.
